(19) United States
(12) Patent Application Publication
(10) Pub. No.: US 2026/0086865 A1
(43) Pub. Date: Mar. 26, 2026

(54) SYSTEM

(71) Applicant: TOYOTA JIDOSHA KABUSHIKI KAISHA, Toyota-shi (JP)

(72) Inventor: Ryokichi ONISHI, Setagaya-ku (JP)

(73) Assignee: TOYOTA JIDOSHA KABUSHIKI KAISHA, Toyota-shi (JP)

(21) Appl. No.: 19/313,185

(22) Filed: Aug. 28, 2025

(30) Foreign Application Priority Data
Sep. 24, 2024 (JP) 2024-165185

(51) Int. Cl. G06F 9/50

(52) U.S. Cl. CPC G06F 9/5027

(57) ABSTRACT

A system controls machine learning of a model in a computing infrastructure including a plurality of nodes that are configured to communicate via a network. The system includes: an acquirer that is configured to acquire learning data information about learning data, and time information indicating a learning deadline; and a selector that is configured to select one or more nodes to be used for machine learning of the model, from the plurality of nodes, based on node information about the plurality of nodes, the learning data information, and the time information. The node information includes cost information about a usage cost. The selector selects the one or more nodes such that machine learning is completed within the learning deadline indicated by the time information and such that a cost required for machine learning is reduced.

### INCORPORATION BY REFERENCE

This application is based upon and claims the benefit of priority from Japanese Patent Application No. 2024-165185, filed on Sep. 24, 2024, the disclosure of which is incorporated herein in its entirety by reference.

### TECHNICAL FIELD

Embodiments of the present disclosure relate to technical fields of a system, and more specifically, to a system that selects a data center that performs machine learning.

### BACKGROUND ART

Services using learned/trained models (i.e., AI (Artificial Intelligence)) generated by machine learning have been proposed. For example, JP2022-034850A as Patent Literature 1 describes a system that provides safe driving support information based on an output of a learned model, wherein types and installation environments of signs or markings around a vehicle, a driving status of the vehicle, a position of the vehicle, and a vehicle driver's line of sight direction are inputted into the learned model.

In the technique/technology described in Patent Literature 1, the learned model is used in an in-vehicle device, but the learned model may also be used in a data center with higher processing capacity than that of the in-vehicle device. For example, a service that provides the safe driving support information described in Patent Literature 1 requires real-time processing of a relatively small data amount from the vehicle. On the other hand, machine learning for generating a learning model requires processing of a large data amount. That is, a required performance of the data center to be used to provide the above service differs from a required performance of the data center to be used to perform machine learning. Incidentally, a learning model development cost often varies depending on the data center used to develop the learning model (in other words, in which machine learning is performed). If no measures are taken, the learning model development cost may increase, which is technically problematic.

### SUMMARY

In view of the above-described problems, it is an object of the present disclosure to provide a system that is allowed to select a data center such that a learning model development cost is reduced/controlled.

A system according to an aspect of the present disclosure is a system that controls machine learning of a model in a computing infrastructure including a plurality of nodes that are configured to communicate via a network, the system including: an acquirer that is configured to acquire learning data information about learning data, and time information indicating a learning deadline; and a selector that is configured to select one or more nodes to be used for machine learning of the model, from the plurality of nodes, based on node information about the plurality of nodes, the learning data information, and the time information, wherein the node information includes cost information about a usage cost, and the selector selects the one or more nodes such that machine learning is completed within the learning deadline indicated by the time information and such that a cost required for machine learning is reduced.

### BRIEF DESCRIPTION OF THE DRAWINGS

FIG. 1 is a conceptual diagram illustrating a system according to an embodiment;

FIG. 2 is a block diagram illustrating a configuration of an information processing apparatus according to the embodiment;

FIG. 3 is a diagram illustrating an example of computing infrastructure information;

FIG. 4 is a diagram illustrating an example of job information;

FIG. 5 is a diagram illustrating an example of an image for inputting the job information; and

FIG. 6 is a diagram illustrating an example of an image indicating a result of machine learning.

### EMBODIMENT

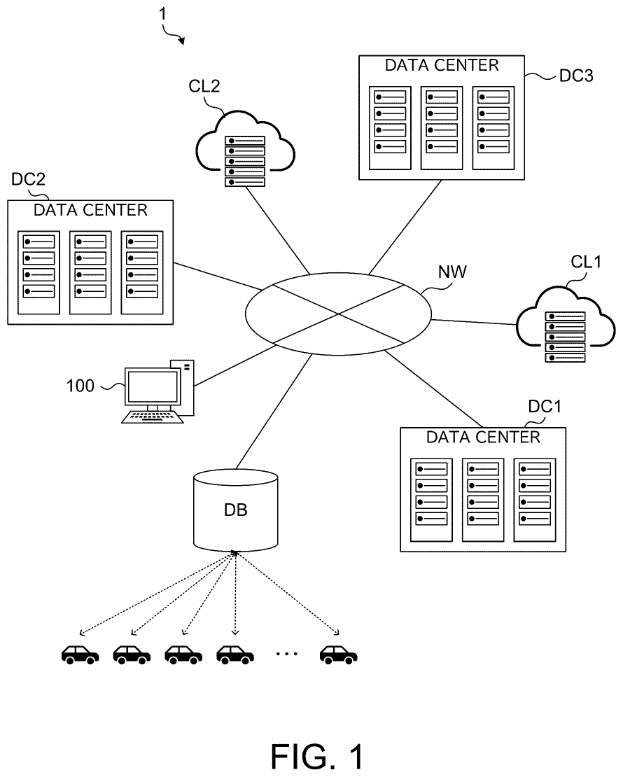

A system according to an embodiment will be described with reference to FIG. 1 to FIG. 6.

### System

The system according to the embodiment will be described with reference to FIG. 1. In FIG. 1, a system 1 includes data centers DC1, DC2, and DC3 connected to each other via a network NW, and clouds CL1 and CL2. The number of the data centers included in the system 1 may be two or less, or four or more. The number of the clouds included in the system 1 may be one, or three or more.

The locations of the data centers DC1, DC2, and DC3 may be arbitrary. For example, the data center DC1 may be located in Japan, the data center DC2 may be located in the United States, and the data center DC3 may be located in Europe. For example, the data center DC1 may be located in Aichi Prefecture, the data center DC2 may be located in Kyushu, and the data center DC3 may be located in Hokkaido.

At least one of the data centers DC1, DC2, and DC3 may be a container-type data center. At least a part of power supplies of the container-type data center may utilize used batteries from BEVs (Battery Electric Vehicles).

At least one of the data centers DC1, DC2, and DC3 may be a data center owned by an own company (i.e., an on-premises type data center). The data centers DC1, DC2, and DC3 may include a data center provided by another business operator (i.e., a hosted type data center). At least one of the clouds CL1 and CL2 may be a public cloud that shares an environment built by a cloud service provider with other users. The clouds CL1 and CL2 may include a hosted type private cloud in which a cloud environment provided by a cloud service provider is exclusively used by a specific user. Note that the hosted type data center and the hosted type private cloud may be considered to be the same concept.

The data centers DC1, DC2, and DC3, as well as the clouds CL1 and CL2, may be referred to as “nodes.” In addition, the network NW may be referred to as a “link.” Therefore, it can be said that the system 1 is a computing infrastructure including a plurality of nodes that are configured to communicate via the network NW.

The system 1 is provided with a database DB. The database DB includes learning data to be used for machine learning. The learning data included in the database DB may be learning data related to commercially available learning datasets. The learning data included in the database DB may be learning data based on data collected from a plurality of vehicles (e.g., connected cars). In the system 1, machine learning using at least a part of the learning data included in the database DB may be performed in at least a part of the data centers DC1, DC2, and DC3, and the clouds CL1 and CL2.

### Configuration of Information Processing Apparatus

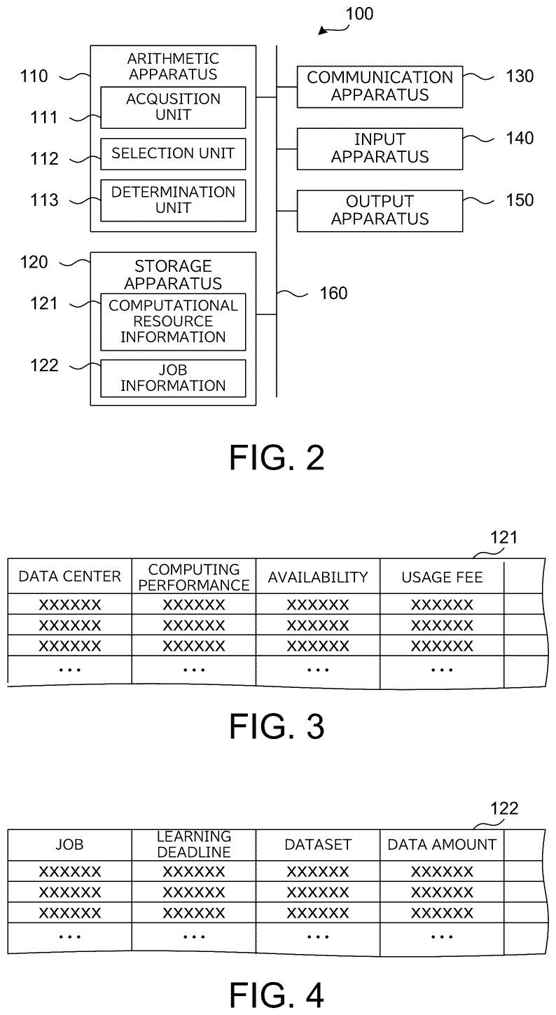

The system 1 is provided with an information processing apparatus 100. The information processing apparatus 100 will be described with reference to FIG. 2. In FIG. 2, the information processing apparatus 100 is provided with an arithmetic apparatus 110, a storage apparatus 120, a communication apparatus 130, an input apparatus 140, and an output apparatus 150. The arithmetic apparatus 110, the storage apparatus 120, the communication apparatus 130, the input apparatus 140, and the output apparatus 150 may be connected via a data bus 160.

The information processing apparatus 100 may not necessarily include at least one of the input apparatus 140 and the output apparatus 150. In this case, at least one of the input apparatus 140 and the output apparatus 150 may be connected to the information processing apparatus 100 via a not-illustrated input/output port of the information processing apparatus 100 (i.e., at least one of the input apparatus 140 and the output apparatus 150 may be attached externally to the information processing apparatus 100).

The arithmetic apparatus 110 may include one or more processors. The processor may be, for example, at least one of a CPU (central processing unit) and a GPU (graphics processing unit). The storage apparatus 120 may include one or more memories. The memory may be, for example, at least one of a RAM (Random Access Memory), a ROM (Read Only Memory), a hard disk apparatus, a magneto-optical disk apparatus, and a SSD (Solid State Drive).

The communication apparatus 130 may be configured to communicate with an apparatus external to the information processing apparatus 100. The communication apparatus 130 may perform wired communication or wireless communication.

The input apparatus 140 is an apparatus that is configured to receive an input of information to the information processing apparatus 100 from the outside. The input apparatus 140 may include an operating apparatus (e.g., a keyboard, a mouse, a touch panel, etc.) that is operable by a user of the information processing apparatus 100. The input apparatus 140 may include a recording medium reading apparatus that is configured to read information recorded on a recording medium that is attachable to or detachable from the information processing apparatus 100, such as a USB (Universal Serial Bus) memory. In a case where information is inputted to the information processing apparatus 100 via the communication apparatus 130 (in other words, in a case where the information processing apparatus 100 acquires information via the communication apparatus 130), the communication apparatus 130 may function as an input apparatus.

The output apparatus 150 is an apparatus that is configured to output information to the outside of the information processing apparatus 100. The output apparatus 25 may output, as the above information, visual information such as characters and images, auditory information such as voice/sound, or tactile information such as vibration. The output apparatus 25 may include, for example, at least one of a display, a speaker, a printer, and a vibration motor. The output apparatus 25 may be configured to output information to a recording medium that is attachable to or detachable from the information processing apparatus 100 such as, for example, a USB memory. In a case where the information processing apparatus 100 outputs information via the communication apparatus 130, the communication apparatus 130 may function as an output apparatus.

The storage apparatus 120 is configured to store desired data. The storage apparatus 120 may store therein a computer program to be executed by the arithmetic apparatus 110. The storage apparatus 120 may temporarily store data that are temporarily used by the arithmetic apparatus 110 when the arithmetic apparatus 110 is executing the computer program.

The computer program may be recorded on a computer-readable and non-transitory recording medium. In this case, the information processing apparatus 100 may read the computer program from the above-mentioned recording medium, by using a not-illustrated recording medium reading apparatus. As a result, the computer program may be stored in the storage apparatus 120. At least one of an optical disk, a magnetic medium, a magneto-optical disk, a semiconductor memory, and any other medium configured to store a program may be used as the above-mentioned recording medium.

The computer program may be acquired from a not-illustrated apparatus external to the information processing apparatus 100 via the communication apparatus 130. That is, the information processing apparatus 100 may download the computer program via the communication apparatus 130. As a result, the computer program may be stored in the storage apparatus 120.

The arithmetic apparatus 110 may perform processing to be performed by the information processing apparatus 100, together with the storage apparatus 120 in which the computer program is stored. In other words, the arithmetic apparatus 110 may perform the processing to be performed by the information processing apparatus 100, together with the storage apparatus 120 and the computer program stored in the storage apparatus 120. For example, by the arithmetic apparatus 110 executing the computer program, logical function blocks for performing the processing to be performed by the information processing apparatus 100, may be realized in the arithmetic apparatus 110.

For example, the arithmetic apparatus 110 may include an acquisition unit 111, a selection unit 112, and a determination unit 113, as the above function blocks. The arithmetic apparatus 110 may include the acquisition unit 111, the selection unit 112, and the determination unit 113, as physically realized processing circuits. At least one of the acquisition unit 111, the selection unit 112, and the determination unit 113 may be realized in a mixed form of a logical function block and a physical processing circuit (i.e., hardware). The acquisition unit 111, the selection unit 112, and the determination unit 113 will be described in detail later.

The storage apparatus 120 stores therein computational resource information 121 and job information 122. The computational resource information 121 is information about a computational resource available for machine learning. For example, the computational resource information 121 may be information about each of the data centers DC1, DC2, and DC3, and the clouds CL1 and CL2. For example, as illustrated in FIG. 3, the computational resource information 121 may be information indicating computing performance, availability, and usage fee of each data center. For example, the data center may be represented by information for identifying the data center. For example, the computing performance may be represented by FLOPS (Floating-Point Operations Per Second). For example, the availability may be represented by the number of available cores.

The “data center” in FIG. 3 is not limited to the data centers DC1, DC2, and DC3, but conceptually includes the clouds CL1 and CL2. As described above, the data centers DC1, DC2, and DC3, as well as the clouds CL1 and CL2, may be referred to as “nodes.” Therefore, the computational resource information 121 may also be referred to as node information. Furthermore, the computational resource information 121 may include other items, in addition to “data center,” “computing performance,” “availability,” and “usage fee.”

The job information 122 is information about a job related to machine learning. For example, as illustrated in FIG. 4, the job information 122 may be information indicating a learning deadline, a dataset, and a data amount of each job. For example, the learning deadline may be a date indicating a learning deadline, or may be a period from the present to a learning deadline. For example, the dataset may be represented by information for identifying a dataset used for machine learning. For example, the data amount may be information indicating a data amount of the dataset. The job information 122 may include other items, in addition to “job,” “learning deadline,” “dataset,” and “data amount.”

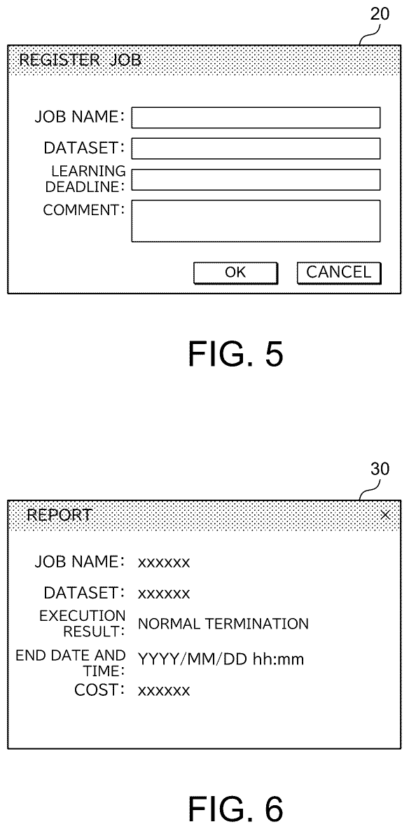

When the user of the information processing apparatus 100 registers a job, an image 20 illustrated in FIG. 5 may be displayed on a display serving as an example of the output apparatus 150. For example, the user may enter necessary information in at least one of a plurality of input fields included in the image 20 via the input apparatus 140. When the user presses an “OK” button included in the image 20 via the input apparatus 140, the information inputted by the user is registered in the job information 122.

For example, information entered in an input field related to “Job name” in the image 20 may be stored in a “Job” field of the job information 122. For example, information entered in an input field related to “Dataset” in the image 20 may be stored in a “Dataset” field of the job information 122. For example, information entered in an input field related to “Learning Deadline” in the image 20 may be stored in a “Learning Deadline” field of the job information 122. For example, the information processing apparatus 100 may identify the data amount of the dataset, based on the information entered in the input field related to “Dataset” in the image 20. The information processing apparatus 100 may store the identified data amount in a “Data amount” field of the job information 122.

### Operation of Information Processing Apparatus

Next, the operation of the information processing apparatus 100 will be described. Explained here is processing in which the information processing apparatus 100 selects a data center that performs machine learning corresponding to a job included in the job information 122. Hereinafter, the “data center” is not limited to the data centers DC1, DC2, and DC3, but also conceptually includes the clouds CL1 and CL2.

The acquisition unit 111 of the arithmetic apparatus 110 acquires the data amount and the learning deadline related to one job included in the job information 122. The selection unit 112 of the arithmetic apparatus 110 may calculate the computing performance necessary to complete machine learning corresponding to one job within the learning deadline, based on the acquired data amount and the acquired learning deadline.

The selection unit 112 may extract one or more data centers that are allowed to satisfy the calculated computing performance (in other words, that are allowed to complete the machine learning corresponding to one job within the learning deadline), based on the computational resource information 121. The selection unit 112 selects the data center that performs the machine learning corresponding to one job, from the extracted one or more data centers, such that the cost required for machine learning is reduced. The selection unit 112 may select one data center that performs machine learning. The selection unit 112 may select a plurality of data centers that perform machine learning. When the selection unit 112 selects a plurality of data centers, the determination unit 113 of the arithmetic apparatus 110 determines learning data to be inputted to each of the plurality of data centers, based on a dataset related to one job.

The selection unit 112 causes the selected data center to perform the machine learning corresponding to one job, via the communication apparatus 130. For example, the selection unit 112 may register one job in a queue related to the selected data center. At this time, the information processing apparatus 100 may transmit the dataset related to one job, to the selected data center from the database DB, based on the job information 122. When the selection unit 112 selects a plurality of data centers, the information processing apparatus 100 may transmit learning data related to one job, to each of the plurality of data centers from the database DB, based on a determination result by the determination unit 113.

Here, the usage fee of the data center varies for each data center. The usage fee is relatively low for the “on-premises type” and is relatively high for the “public cloud.” The usage fee of the “hosted type” is often higher than that of the “on-premises type” and is lower than that of the “public cloud.”

For example, in a case where the extracted one or more data centers described above include both the on-premises type and the public cloud, the selection unit 112 may select the on-premises type such that the cost required for machine learning is reduced. For example, in a case where the extracted one or more data centers described above include the hosted type and the public cloud, the selection unit 112 may select the hosted type such that the cost required for machine learning is reduced. In a case where the selection unit 112 selects a plurality of data centers that performs the machine learning corresponding to one job, the selection unit 112 may preferentially select the on-premises type such that the cost required for machine learning is reduced.

When the machine learning corresponding to one job is completed, the information processing apparatus 100 may acquire result information indicating a result of one job from the data center. The information processing apparatus 100 may store the result information in the storage apparatus 120. A user of the information processing apparatus 100 may cause the information processing apparatus 100 to display the result information via the input apparatus 140. In this case, the information processing apparatus 100 may display an image 30 illustrated in FIG. 6, on a display serving as an example of the output apparatus 150.

### Application Example

A learned/trained model generated by machine learning using the above-described system 1 may be applied, for example, to an advanced drive assistance function (Advanced Drive/Advanced Drive Assistance System).

For example, a base model related to the advanced drive assistance function may be generated, as the learned model, by machine learning using the system 1 and commercially available learning datasets included in the database DB. Furthermore, the base model may be fine-tuned by machine learning using the system 1 and learning data that are based on data collected from a plurality of vehicles traveling in a specific region and that are included in the database DB. As a result, a learning model related to the advanced drive assistance function optimized for the specific region may be generated. Note that LORA (Low-Rank Adaptation) may be used for fine-tuning.

### Technical Effect

AI may be utilized to provide a safer and more comfortable driving environment for vehicles. For example, operational support of peripheral devices such as air conditioner and an audio system, support for safer driving, or the like, may be realized by executing the learned model (i.e., AI) related to the advanced drive assistance function on an in-vehicle device. By executing a learning model related to the advanced drive assistance function, on a server on a network, in addition to or instead of the in-vehicle device, more enhanced services may be provided to a vehicle user, via the communication apparatus mounted on a vehicle. A server that provides such services needs to respond in real time to a user's requests. However, it is only a relatively small amount of data that are inputted to the server.

For example, in order to develop the AI related to the advanced drive assistance function, a server that performs machine learning (corresponding to a server included in the aforementioned data center) needs to process a large amount of data. However, real-time response is not required in case of sticking to a predetermined development schedule. In other words, a processing time may not necessarily be short in case of sticking to the predetermined development schedule. Thus, the server that executes the learned model and the server that performs machine learning are required to have different performances.

As described above, the usage fee often varies depending on the data center. In the system 1 according to the present embodiment, the information processing apparatus 100 selects the data center such that machine learning is completed within the learning deadline and such that the cost required for machine learning is reduced. That is, in the system 1, a relatively low-cost data center is preferentially selected as the data center that performs machine learning, while sticking to a predetermined development schedule. Therefore, according to the system 1 in the present embodiment, it is possible to select the data center such that a learning model development cost is reduced/controlled.

The system 1 may include an on-premises type data center that satisfies a stable computing demand of an own company and at least one of a hosted type private cloud and a public cloud that satisfies the remaining computing demand of the own company. The information processing apparatus 100 may select the data center such that machine learning is completed within the learning deadline and such that the cost required for machine learning is reduced. With this configuration, it is possible to reduce/control the learning model development cost, while satisfying the computing demand of the own company.

### First Modified Example

The computational resource information 121 may further include environmental impact information indicating an environmental impact related to the data center. For example, the environmental impact information may include an index indicating the environmental impact. For example, the environmental impact information may include information indicating a type of energy used by the data center. The type of energy may include, for example, green energy, renewable energy, fossil energy, and the like.

For example, the selection unit 112 of the information processing apparatus 100 may select the data center that performs machine learning such that the cost required for machine learning is reduced and such that the environmental impact is reduced, based on the computational resource information 121. With this configuration, it is possible to reduce the environmental impact, while reducing the learning model development cost.

### Second Modified Example

The computational resource information 121 may further include power information about a power supply situation in an area including the data center. The information indicating the power supply situation may include, for example, an amount of power generated by solar power generation, an amount of power generated by wind power generation, an amount of power stored in storage batteries, presence/absence of output suppression, and the like.

For example, the selection unit 112 of the information processing apparatus 100 may select the data center that performs machine learning such that the cost required for machine learning is reduced, based on the computational resource information 121. For example, the selection unit 112 may preferentially select a data center in a region with a relatively large power supply capacity, among data centers with relatively low usage fees.

For example, the amount of power generated by solar power generation and wind power generation is easily affected by weather conditions. When the amount of power generated by at least one of solar power generation and wind power generation exceeds a usage amount, at least one of solar power generation and wind power generation is temporarily stopped. That is, there are cases where solar power generation and wind power generation cannot be fully utilized. The data center consumes a relatively large amount of electricity. With the above configuration, it is possible to prevent at least one of solar power generation and wind power generation suppress from being temporarily stopped, while reducing the learning model development cost.

### Third Modified Example

The computational resource information 121 may further include the environmental impact information indicating the environmental impact related to the data center, and the power information about the power supply situation in the area including the data center. The selection unit 112 of the information processing apparatus 100 may select the data center that performs machine learning such that the cost required for machine learning is reduced and such that the environmental impact is reduced, based on the computational resource information 121. For example, the selection unit 112 may preferentially select a data center in a region with a relatively large power supply capacity, among data centers with relatively low usage fees and with relatively small environmental impacts.

For example, the selection unit 112 may calculate a monetary score related to the usage fee, an environmental score related to the environmental impact, and a power score related to the power supply situation. Here, the monetary score may be smaller as the usage fee is lower. The environmental score may be smaller as the environmental impact is lower. The power score may be smaller as the power supply capacity is larger.

For example, the selection unit 112 may calculate a score related to one data center as “w1×(monetary score)+w2×(environmental score)+w3×(power score).” Here, “w1,” “w2,” and “w3” are weights. The weight w1 is greater than the weights w2 and w3. A size relationship of the weights w2 and w3 may be determined according to a user's policy. The selection unit 112 may select a data center with the smallest score, as the data center that performs machine learning.

With this configuration, for example, it is possible to reduce the environmental impact while reducing the learning model development cost, and furthermore, to prevent at least one of solar power generation and wind power generation from being temporarily stopped.

Aspects of the present disclosure derived from the embodiment and modified examples described above will be described below.

A system according to an aspect of the present disclosure is a system that controls machine learning of a model in a computing infrastructure including a plurality of nodes that are configured to communicate via a network, the system including: an acquirer that is configured to acquire learning data information about learning data, and time information indicating a learning deadline; and a selector that is configured to select one or more nodes to be used for machine learning of the model, from the plurality of nodes, based on node information about the plurality of nodes, the learning data information, and the time information, wherein the node information includes cost information about a usage cost, and the selector selects the one or more nodes such that machine learning is completed within the learning deadline indicated by the time information and such that a cost required for machine learning is reduced.

In the above embodiment, “the data centers DC1, DC2, and DC3, and the clouds CL1 and CL2” correspond to an example of the “nodes.” The “acquisition unit 111” corresponds to an example of the “acquirer,” the “selection unit 112” corresponds to an example of the “selector,” and the “computational resource information 121” corresponds to an example of the “node information.”

In an example of the system, the plurality of nodes may include at least two of on-premises, a private cloud, and a public cloud.

In another example of the system, the node information may include performance information about computing performance of each of the plurality of nodes, and the selector may select the one or more nodes such that an end of machine learning is close to the learning deadline indicated by the time information and such that the cost required for machine learning is reduced.

In another example of the system, the system may further include a determinator that is configured to determine, in response to selection of two or more nodes as the one or more nods, learning data to be inputted to each of the two or more nodes, based on the learning data information. In the above embodiment, the “determination unit 113” corresponds to an example of the “determinator.”

In another example of the system, the node information may include environmental impact information about an environmental impact of each of the plurality of nodes, and the selector may select the one or more nodes, based on the node information, such that machine learning is completed within the learning deadline indicated by the time information, such that the cost required for machine learning is reduced, and such that the environmental impact is reduced.

In another example of the system, the node information may include power information about a regional power situation, and the selector may select the one or more nodes, based on the node information, such that machine learning is completed within the learning deadline indicated by the time information and such that the cost required for machine learning is reduced.

In another example of the system, the node information may include environmental impact information about an environmental impact of each of the plurality of nodes, and power information about a regional power situation, and the selector may select the one or more nodes, based on the node information, such that machine learning is completed within the learning deadline indicated by the time information, such that the cost required for machine learning is reduced, and such that the environmental impact is reduced.

In another example of the system, the system may further include an outputter that is configured to output a report on machine learning, in response to completion of machine learning of the model, wherein the report includes information about a cost. In the above embodiment, the “output apparatus 150” corresponds to an example of the “outputter.”

In another example of the system, the system may further include an outputter that is configured to output an input screen including an input field for entering the learning deadline.

A control method according to an aspect of the present disclosure is a control method that controls machine learning of a model in a computing infrastructure including a plurality of nodes that are configured to communicate via a network, the control method including: acquiring learning data information about learning data, and time information indicating a learning deadline; and selecting one or more nodes to be used for machine learning of the model, from the plurality of nodes, based on node information about the plurality of nodes, the learning data information, and the time information, wherein the node information includes cost information about a usage cost, and the selection unit selects the one or more nodes such that machine learning is completed within the learning deadline indicated by the time information and such that a cost required for machine learning is reduced.

The present disclosure is not limited to the above-described examples and is allowed to be changed, if desired, without departing from the essence or spirit of the invention which can be read from the claims and the entire specification. A system with such changes is also included in the technical concepts of the present disclosure.

### DESCRIPTION OF REFERENCE NUMERALS

1: System, 100: Information processing apparatus, 111: Acquisition unit, 112: Selection unit, 113: Determination unit, DB: Database, DC1, DC2, DC3: Data center, CL1, CL2: Cloud, NW: Network

What is claimed is:

1. A system that controls machine learning of a model in a computing infrastructure including a plurality of nodes that are configured to communicate via a network, the system comprising:
an acquirer that is configured to acquire learning data information about learning data, and time information indicating a learning deadline; and
a selector that is configured to select one or more nodes to be used for machine learning of the model, from the plurality of nodes, based on node information about the plurality of nodes, the learning data information, and the time information, wherein
the node information includes cost information about a usage cost, and
the selector selects the one or more nodes such that machine learning is completed within the learning deadline indicated by the time information and such that a cost required for machine learning is reduced.

2. The system according to claim 1, wherein the plurality of nodes include at least two of on-premises, a private cloud, and a public cloud.

3. The system according to claim 1, wherein
the node information includes performance information about computing performance of each of the plurality of nodes, and
the selector selects the one or more nodes such that an end of machine learning is close to the learning deadline indicated by the time information and such that the cost required for machine learning is reduced.

4. The system according to claim 1, further comprising a determinator that is configured to determine, in response to selection of two or more nodes as the one or more nods, learning data to be inputted to each of the two or more nodes, based on the learning data information.

5. The system according to claim 1, wherein
the node information includes environmental impact information about an environmental impact of each of the plurality of nodes, and
the selector selects the one or more nodes, based on the node information, such that machine learning is completed within the learning deadline indicated by the time information, such that the cost required for machine learning is reduced, and such that the environmental impact is reduced.

6. The system according to claim 1, wherein
the node information includes power information about a regional power situation, and
the selector selects the one or more nodes, based on the node information, such that machine learning is completed within the learning deadline indicated by the time information and such that the cost required for machine learning is reduced.

7. The system according to claim 1, wherein
the node information includes environmental impact information about an environmental impact of each of the plurality of nodes, and power information about a regional power situation, and
the selector selects the one or more nodes, based on the node information, such that machine learning is completed within the learning deadline indicated by the time information, such that the cost required for machine learning is reduced, and such that the environmental impact is reduced.

8. The system according to claim 1, further comprising an outputter that is configured to output a report on machine learning, in response to completion of machine learning of the model, wherein
the report includes information about a cost.

9. The system according to claim 1, further comprising an outputter that is configured to output an input screen including an input field for entering the learning deadline.
